(19) United States
(12) Patent Application Publication
(10) Pub. No.: US 2011/0039517 A1
(43) Pub. Date: Feb. 17, 2011

(54) Radio Fingerprinting Using E-UTRAN Measurements

(75) Inventors: Torbjörn Wigren, Uppsala (SE); Dirk Gerstenberger, Stockholm (SE); Martin Israelsson, Spanga (SE); Muhammad Kazmi, Bromma (SE)

Correspondence Address: POTOMAC PATENT GROUP PLLC, P. O. BOX 270, FREDERICKSBURG, VA, 22404, US

(73) Assignee: Telefonaktiebolaget L M Ericsson (publ), Stockholm (SE)

(21) Appl. No.: 12/989,363

(22) PCT Filed: Apr. 29, 2008
(86) PCT No.: PCT/SE08/50491

§ 371 Date: Oct. 22, 2010

(51) Int. Cl. H04W 4/22; H04W 24/00

(52) U.S. Cl. 455/404.2; 455/456.1

(57) ABSTRACT

A system obtains geographic positions associated with location points of multiple user equipments (UEs) in a wireless network and receives Evolved Universal Terrestrial Radio Access Network (E-UTRAN) radio fingerprint data associated with radio measurements performed at the location points by the multiple UE or performed by eNodeBs associated with the multiple UEs. The system clusters the location points based on similarities between the E-UTRAN radio fingerprint data to create cluster boundaries and stores the geographic positions, cluster boundaries and the E-UTRAN radio fingerprint data in a database for future determination of UE geographic positions using the E-UTRAN radio fingerprint data. The system receives E-UTRAN radio fingerprint measurement data associated with a first UE in the wireless network and performs a lookup operation into the database to retrieve one of the geographic positions that corresponds to the E-UTRAN radio fingerprint measurement data. The system sends the one of the geographic positions to at least one of the first UE, an emergency or police call center, a geographic information system (GIS) server or a node external to the wireless network.

### TECHNICAL FIELD

Implementations described herein relate generally to geographic position determination in wireless systems.

### BACKGROUND

Localization-based services are becoming increasingly important for cellular network operators. A major driving force for the increased importance of localization-based services is the requirement for E-911 emergency positioning in the North American market. The E-911 emergency positioning requirement calls for accuracies of 50-150 m for terminal-based positioning and 100-300 m for network-based positioning. Similar requirements exist in Japan, where assisted Global Positioning System (A-GPS) has been mandatory in wireless handsets since 2007. In other markets, where emergency positioning has not been mandated, commercial applications of cellular-location technology have become increasingly popular, including the use of cellular-location technology for friend finding, fleet management, location-based gaming, personal navigation, and other applications.

The basic positioning method in most cellular-communication systems is the cell-identity (cell-ID) method. The cell-identity method reports the identity or a geographical description of the cell of the cellular network to which the user equipment is connected. The cell-identity method can be applied in all situations where there is cellular coverage. The cell-identity method has a principal advantage in that it has a very short response time—the cell ID of a user equipment (UE) is normally stored in the system together with other basic information related to the UE's connection and can be quickly and easily retrieved to determine the user equipment's cell location. However, the mere identification of a cell to which a given user equipment is connected may be insufficiently accurate for many applications in which a location of the user equipment is needed.

### SUMMARY

Exemplary embodiments described herein implement an adaptive enhanced cell identification (AECID) positioning method that uses Evolved Universal Terrestrial Radio Access Network (E-UTRAN) radio measurements as radio “fingerprints” in a positioning technique that can provide geographic positions to user equipment devices (UEs) (e.g., radiotelephones) that may not have built-in positioning devices, such as, for example, Global Positioning System (GPS) devices. As described herein, a database of radio fingerprints may be accumulated using accurate geographic positions of devices at multiple location points in a wireless network, and associated E-UTRAN radio fingerprint measurements performed at those location points, that are provided to a geographic position determining node. The accurate geographic positions may be measured using, for example, GPS devices that may be built in to certain devices (e.g., resident in some of the radiotelephones). Thus, for each location point in the wireless network at which a device reports an accurate geographic position, the device additionally obtains E-UTRAN radio fingerprint measurement data and reports the fingerprint measurement data to the positioning node. The positioning node aggregates numerous reported geographic positions, and their associated E-UTRAN radio fingerprints, to create a database of radio fingerprints that can subsequently be used to retrieve geographic positions of other UEs that may not have built-in GPS technology. Therefore, E-UTRAN measurements may be performed at a given UE, or at the evolved Node B (eNodeB) station that serves the UE, and the E-UTRAN measurements may be provided to a geographic position determining node as an E-UTRAN radio fingerprint that may be used to match a corresponding radio fingerprint stored in the database. A geographic position stored in the database that corresponds to the matching radio fingerprint may be retrieved as the UEs current geographic position. The retrieved geographic position may be reported back to the UE, to an emergency or police call center, or to another node.

According to one aspect, a method implemented in a positioning node associated with a wireless network, where geographic positions, associated with location points of multiple UEs in a wireless network, are obtained, may include receiving E-UTRAN radio fingerprint data associated with radio measurements performed at the location points by the multiple UE or performed by eNodeBs associated with the multiple UEs. The method may further include clustering the location points based on similarities between the E-UTRAN radio fingerprint data to create cluster boundaries; and storing the geographic positions, cluster boundaries and the E-UTRAN radio fingerprint data in a database for future determination of UE geographic positions using the E-UTRAN radio fingerprint data.

According to a further aspect, a UE device may include a transceiver configured to perform radio measurements to obtain E-UTRAN radio fingerprint measurement data associated with a geographic position of the UE device, where the E-UTRAN radio fingerprint measurement data comprises at least one of: Evolved Universal Terrestrial Radio Access (E-UTRA) Reference Signal Received Power (RSRP) measured at the UE, E-UTRA Carrier Received Signal Strength Indicator (RSSI) measured at the UE, E-UTRA Reference Signal Received Quality (RSRQ) measured at the UE. Wideband Code Division Multiple Access (WCDMA) UTRA Frequency Division Duplex (FDD) Common Pilot Channel (CPICH) Received Signal Code Power (RSCP) measured at the UE, WCDMA UTRA FDD carrier RSSI measured at the UE, WCDMA UTRA FDD CPICH Ec/No, corresponding to a received energy per chip divided by a power density in a band, measured at the UE, Global System for Mobile Communications (GSM) carrier RSSI measured at the UE, Time division duplex (TDD) mode UTRA TDD carrier RSSI measured at the UE, UTRA TDD Primary Common Control Physical to Channel (P-CCPCH) RSCP measured at the UE, CDMA2000 1 times Radio Transmission Technology (1×RTT) pilot strength measured at the UE, or CDMA2000 High Rate Packet Data (HRPD) pilot strength measured at the UE. The UE device may further include a processing unit configured to: cause the E-UTRAN radio fingerprint measurement data to be sent to a geographic position determining node, and receive a current geographic position from the geographic position determining node responsive to sending the E-UTRAN radio fingerprint measurement data.

According to an additional aspect, a system associated with a wireless network may include a database and an interface configured to: receive geographic positions associated with location points of multiple UE in the wireless network obtained using a Global Positioning System (GPS) device, and receive E-UTRAN radio fingerprint data associated with radio measurements performed at the location points of the multiple UE. The system may further include a processing unit to: cluster the location points based on similarities between the E-UTRAN radio fingerprint data to create cluster boundaries. and store the geographic positions, cluster boundaries and the E-UTRAN radio fingerprint data in the database for future determination of UE geographic positions using the E-UTRAN radio fingerprint data without the use of a GPS device.

### BRIEF DESCRIPTION OF THE DRAWINGS

FIG. 1 illustrates an exemplary communications system;

FIG. 2 illustrates an exemplary implementation in which the system of FIG. 1 includes a Public Land Mobile Network (PLMN);

FIG. 3 illustrates exemplary components of an eNodeB of the PLMN of FIG. 2;

FIG. 4A illustrates exemplary components of a user equipment device of FIG. 1;

FIG. 4B illustrates an exemplary implementation of a user equipment device of FIG. 1 where the device is a cellular radiotelephone;

FIG. 5A is a diagram that depicts the uplink transmission of Evolved Universal Terrestrial Radio Access Network (E-UTRAN) radio fingerprint measurement data from a user equipment device to an eNodeB in a cell of a wireless network;

FIG. 5B is a diagram that depicts the downlink transmission of the user equipment device's position from the eNodeB of FIG. 5A to the user equipment after the performance of a radio fingerprint look-up at the positioning node;

FIG. 6 is a flowchart of an exemplary process for constructing a radio fingerprint database based on E-UTRAN radio measurements received from multiple user equipment devices;

FIG. 7 is a flowchart of an exemplary process for determining a user equipment device's geographic position based on E-UTRAN radio fingerprint measurement data associated with a position of the user equipment device;

FIG. 8 is a messaging diagram that depicts the transmission of E-UTRAN radio fingerprint measurement data from a user equipment device to an eNodeB, and from the eNodeB to a positioning node that determines the user equipment device's geographic position based on the fingerprint measurement data;

FIG. 9 is a messaging diagram that depicts the transmission of the user equipment device's geographic position, determined based on E-UTRAN radio fingerprint measurement data received at the positioning node, from the positioning node to the eNodeB, and from the eNodeB to the user equipment device;

FIG. 10 is a messaging diagram that depicts the transmission of the user equipment device's geographic position, determined based on E-UTRAN radio fingerprint measurement data received at the positioning node, from the positioning node to a Geographic Information System server;

FIG. 11 is a messaging diagram that depicts the transmission of E-UTRAN radio fingerprint measurement data from a user equipment device to a first eNodeB, and from the first eNodeB to a second eNodeB; and

FIG. 12 is a messaging diagram that depicts the transmission of E-UTRAN radio fingerprint measurement data from a user equipment device to an eNodeB, and from the eNodeB to a Geographic Information System server.

### DETAILED DESCRIPTION

The following detailed description of the invention refers to the accompanying drawings. The same reference numbers in different drawings may identify the same or similar elements. Also, the following detailed description does not limit the invention.

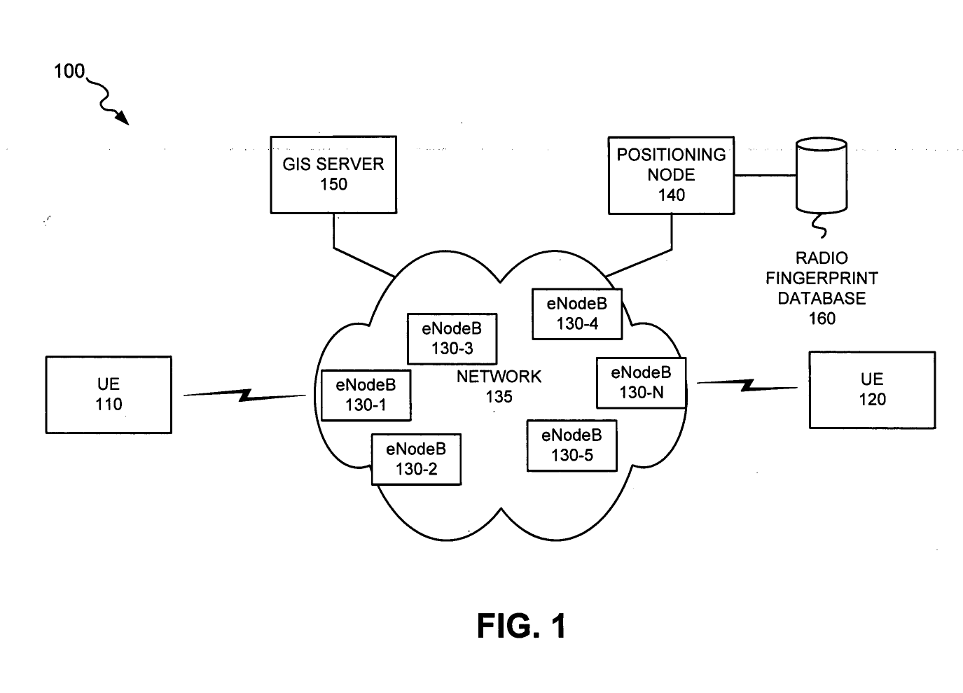

FIG. 1 illustrates an exemplary communications system 100 that may include user equipments (UEs) 110 and 120, a positioning node 140 and a geographic information system (GIS) server connected to a network 135. UE 110 may communicate with UE 120 (or with other devices not shown) via a network 135 in system 100. In one implementation. UE 110 may communicate with UE 120 via one or more other devices that act as intermediate devices between UE 110 and UE 120. For example, as shown in FIG. 1, an evolved node B (eNodeB) 130-1, which may include wireless base station functionality, may reside as an intermediate component of network 135 that may be used to facilitate end-to-end communication between UE 110 and 120 or between UE and positioning node 140 or GIS server 150. Additional eNodeBs 130-2 through 130-N may reside in network 135.

UEs 110 and/or 120 may include a cellular radiotelephone, a personal digital assistant (PDA), a Personal Communications Systems (PCS) terminal, a laptop computer, a palmtop computer, or any other type of device or appliance that includes a communication transceiver that permits the device to communicate with other devices via a wireless link. A PCS terminal may combine a cellular radiotelephone with data processing, facsimile and data communications capabilities. A PDA may include a radiotelephone, a pager, an Internet/intranet access device, a web browser, an organizer, calendars and/or a global positioning system (GPS) receiver. One or more of UEs 110 and 120 may be referred to as a “pervasive computing” device. In some implementations, UE 120 may include a telephone (e.g., a Plain Old Telephone system (POTS) telephone) that is connected to a Public Switched Telephone Network (PSTN).

eNodeBs 130-1 through 130-N may interface with respective UEs (e.g., eNodeB 130-1 may interface with UE 110) via respective wireless links and may perform, among other functions, medium access control (MAC) and radio link control (RLC).

Positioning node 140 may determine the location of UEs in system 100. Positioning node 140 may be associated with a radio fingerprint database 160 that stores radio fingerprints derived from Evolved Universal Terrestrial Radio Access Network (E-UTRAN) and/or inter-Radio Access Technology (IRAT) measurement data. Database 160 may reside internal or external to positioning node 140. The E-UTRAN and/or IRAT measurement data may be provided to positioning node 140, in conjunction with precise geographic position data obtained at the same geographic location at which the E-UTRAN and/or IRAT measurements were performed (e.g., GPS geographic position data), and positioning node 140 may organize the precise geographic position data into clusters having a same or similar radio fingerprint. Positioning node 140 may further determine the cluster boundaries of each cluster and store the cluster boundary information, associated radio fingerprints, and precise geographic position data in radio fingerprint database 160. Positioning node 140 may subsequently receive E-UTRAN and/or IRAT radio fingerprint measurement data from UE 110 or UE 120 and may perform a lookup into radio fingerprint database 160 to identify a radio fingerprint stored in database 160 that matches the received E-UTRAN and/or IRAT radio fingerprint measurement data, and to retrieve a precise geographic position stored in database 160 that corresponds to the matching radio fingerprint. Positioning node 140 may provide this geographic position to the UE that sent the radio fingerprint measurement data, or to other destinations, such as, for example, an emergency or police call center.

GIS server(s) 150 may include one or more server entities that provide geographic mapping services, or related mapping services. GIS server(s) 150 may receive UE geographic position data from positioning node 140, or from a UE (e.g., UE 110 or 120) and may map the received geographic position data to physical coordinates or a physical address, or perform other mapping related services with the geographic position data.

Network(s) 135 may include one or more networks of any type, including a local area network (LAN); a wide area network (WAN); a metropolitan area network (MAN); a telephone network, such as a PSTN or a PLMN; a satellite network; an intranet, the Internet; or a combination of networks. The PLMN(s) may further include a packet-switched sub-network, such as, for example, General Packet Radio Service (GPRS), Cellular Digital Packet Data (CDPD), or Mobile IP network.

It will be appreciated that the number of components illustrated in FIG. 1 is purely exemplary. Other configurations with more, fewer, or a different arrangement of components may be implemented. Moreover, in some embodiments, one or more components in FIG. 1 may perform one or more of the tasks described as being performed by one or more other components in FIG. 1.

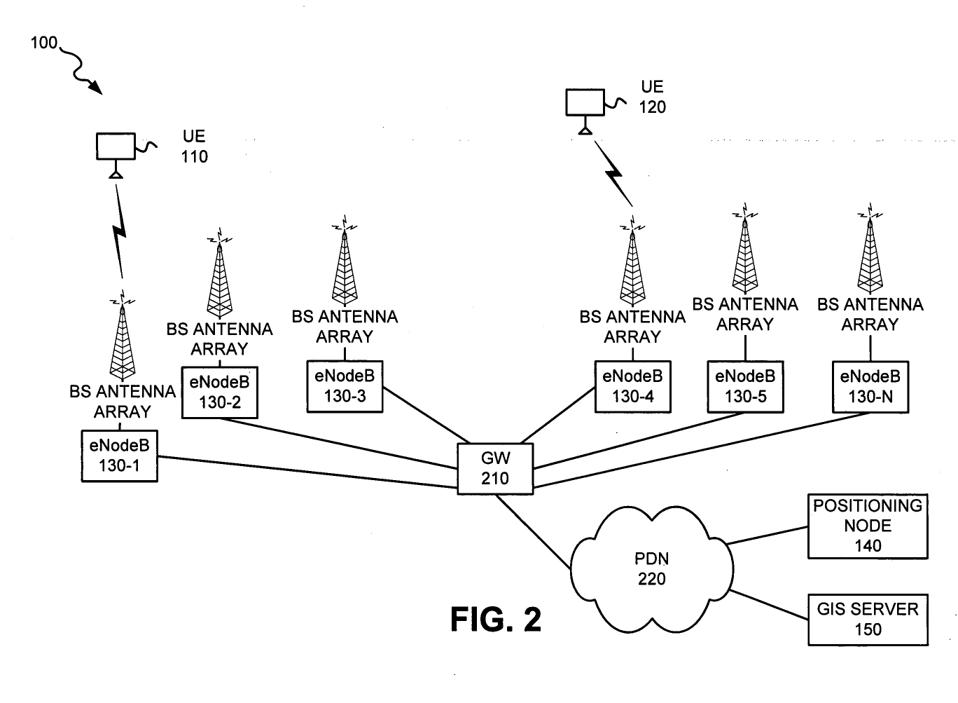

FIG. 2 illustrates an example of system 100 of FIG. 1, where system 100 includes a PLMN. The PLMN may implement a Long Term Evolution (LTE) system architecture. As shown in FIG. 2, UEs 110 and 120 may include cellular radiotelephones that are communicating with one another via the PLMN. The PLMN may include multiple eNodcBs 130-1 through 130-N along with their associated antenna arrays and one or more gateways (e.g., one gateway 210 shown). Gateway 210 may further connect to a packet data network (PDN) 220 of system 100 which may further connect to positioning node 140 and GIS server 150. PDN 220 may include any type of packet-switched network, such as, for example, the Internet.

eNodeBs 130-1 through 130-N may interface with respective UEs (e.g., eNodeB 130-1 may interface with UE 110) via respective wireless links and may perform, among other functions, medium access control (MAC) and radio link control (RLC). For example, eNodeB 130-1 may receive data transmissions from UE 110 and may forward those data transmissions on to GW 210. GW 210 may route data transmissions received from a respective eNodeB to another eNodeB, or to positioning node 140 or GIS server 150 via PDN 220. GW 210 may further route data transmissions received from positioning node 140 or GIS server 150 via PDN 220 to a respective eNodeB 130-1 through 130-N associated with a destination UE. Though positioning node 140 is shown in FIG. 2 as connected to the PLMN by way of PDN 220, in other implementations, positioning node 140 may reside as a component of PLMN (e.g., connected internally to the PLMN without messaging having to traverse PDN 220).

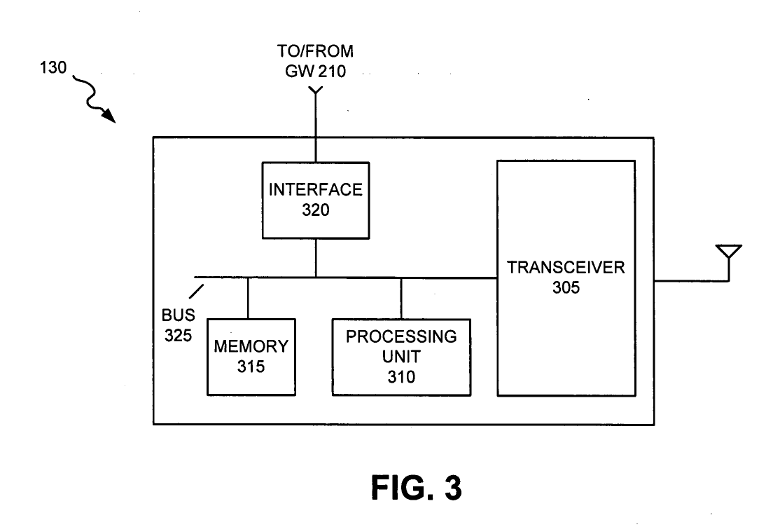

FIG. 3 illustrates one exemplary implementation of eNodeB 130-1. eNodeBs 130-2 through 130-N may be similarly configured. Positioning node 140 and GIS server 150 may also be similarly configured (however, positioning node 140 and GIS server 150 may not include transceiver 305). eNodeB 130-1 may include a transceiver 305, a processing unit 310, a memory 315, an interface 320 and a bus 325.

Transceiver 305 may include transceiver circuitry for transmitting and/or receiving symbol sequences using radio frequency signals via one or more antennas. The one or more antennas may include a single antenna or an antenna array and may include directional and/or omni-directional antennas. Transceiver 305 may additionally include measurement circuitry that may perform one or more of various different Evolved Universal Terrestrial Radio Access Network (E-UTRAN) radio fingerprint measurements, such as, for example, measuring the Evolved Universal Terrestrial Radio Access (E-UTRA) Downlink Reference Signal transmit (DL RS) power at eNodeB 130-1.

Processing unit 310 may include a processor, microprocessor, or processing logic that may interpret and execute instructions. Processing unit 310 may perform all data processing functions for eNodeB 130-1. Memory 315 may provide permanent, semi-permanent, or temporary working storage of data and instructions for use by processing unit 310 in performing device processing functions. Memory 315 may include read only memory (ROM), random access memory (RAM), large-capacity storage devices, such as a magnetic and/or optical recording medium and its corresponding drive, and/or other types of memory devices. Interface 320 may include circuitry for interfacing with a link that connects to GW 210. Bus 325 may interconnect the various components of device 130-1 to permit the components to communicate with one another.

The configuration of components of device 130-1 illustrated in FIG. 3 is for illustrative purposes only. Other configurations with more, fewer, or a different arrangement of components may be implemented.

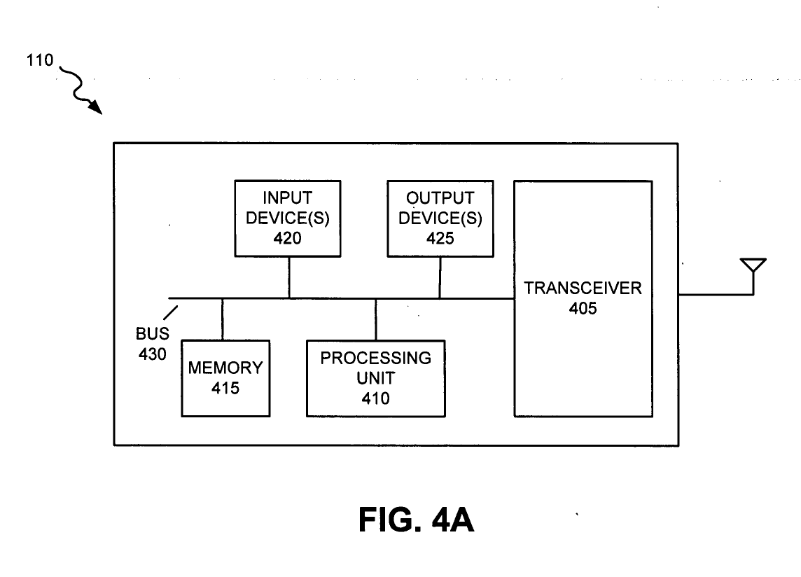

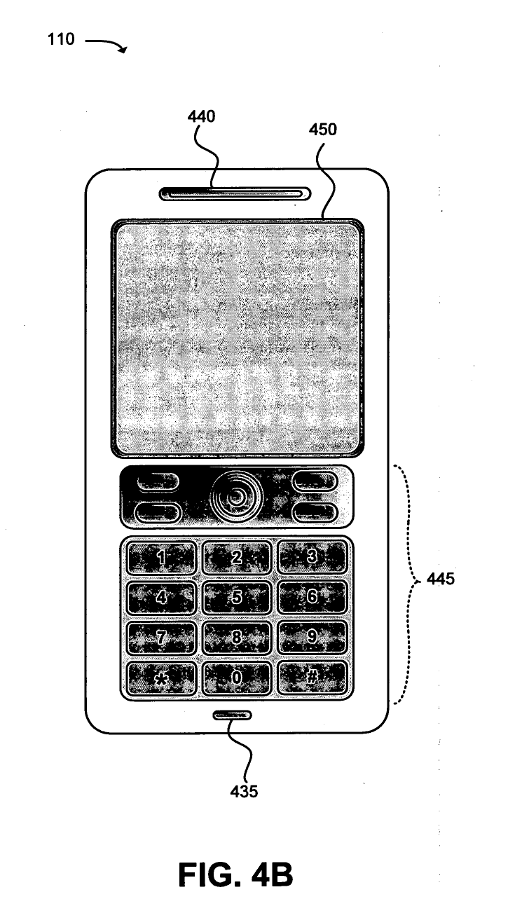

FIG. 4A illustrates UE 110 consistent with an exemplary embodiment. UE device 120 may be similarly configured. UE 110 may include a transceiver 405, a processing unit 410, a memory 415, an input device(s) 420, an output device(s) 425, and a bus 430.

Transceiver 405 may include transceiver circuitry for transmitting and/or receiving symbol sequences using radio frequency signals via one or more antennas. Transceiver 405 may include, for example, a RAKE or a GRAKE receiver. Transceiver 405 may additionally include measurement circuitry that may perform one or more of various different E-UTRAN radio fingerprint measurements, including (but not limited to) one or more of the following: E-UTRA Reference Signal Received Power (RSRP); E-UTRA Carrier Received Signal Strength Indicator (E-UTRA carrier RSSI); E-UTRA Reference Signal Received Quality (RSRQ); Wideband Code Division Multiple Access (WCDMA) UTRA Frequency Division Duplex (FDD) Common Pilot Channel (CPICH) Received Signal Code Power (RSCP); WCDMA UTRA FDD carrier RSSI; WCDMA UTRA FDD CPICH Ec/No (corresponding to a received energy per chip divided by a power density in a band); Global System for Mobile Communications (GSM) carrier RSSI; Time division duplex (TDD) mode UTRA TDD carrier RSSI; UTRA TDD Primary Common Control Physical Channel (P-CCPCI-I) RSCP; CDMA2000 1 times Radio Transmission Technology (1×RTT) pilot strength; and/or CDMA2000 High Rate Packet Data (HRPD) pilot strength.

Processing unit 410 may include a processor, microprocessor, or processing logic that may interpret and execute instructions. Processing unit 410 may perform all data processing functions for inputting, outputting, and processing of data including data buffering and device control functions, such as call processing control, user interface control, or the like.

Memory 415 may provide permanent, semi-permanent, or temporary working storage of data and instructions for use by processing unit 410 in performing device processing functions. Memory 415 may include ROM, RAM, large-capacity storage devices, such as a magnetic and/or optical recording medium and its corresponding drive, and/or other types of memory devices. Input device(s) 420 may include mechanisms for entry of data into UE 110. For example, input device(s) 420 may include a key pad (not shown), a microphone (not shown) or a display unit (not shown). The key pad may permit manual user entry of data into UE 110. The microphone may include mechanisms for converting auditory input into electrical signals. The display unit may include a screen display that may provide a user interface (e.g., a graphical user interface) that can be used by a user for selecting device functions. The screen display of the display unit may include any type of visual display, such as, for example, a liquid crystal display (LCD), a plasma screen display, a light-emitting diode (LED) display, a cathode ray tube (CRT) to display, an organic light-emitting diode (OLED) display, etc.

Output device(s) 425 may include mechanisms for outputting data in audio. video and/or hard copy format. For example, output device(s) 425 may include a speaker (not shown) that includes mechanisms for converting electrical signals into auditory output. Output device(s) 425 may further include a display unit that displays output data to the user. For example, the display unit may provide a graphical user interface that displays output data to the user. Bus 430 may interconnect the various components of UE 110 to permit the components to communicate with one another.

The configuration of components of UE 110 illustrated in FIG. 4A is for illustrative purposes only. Other configurations with more, fewer, or a different arrangement of components may be implemented. For example, in some implementations, UE 110 may include a GPS position measuring device.

FIG. 4B illustrates an exemplary implementation of UE 110 in which UE 110 includes a cellular radiotelephone. As shown in FIG. 4B, the cellular radiotelephone may include a microphone 435 (e.g., of input device(s) 420) for entering audio information into the radiotelephone, a speaker 440 (e.g., of output device(s) 425) for providing an audio output from the radiotelephone, a keypad 445 (e.g., of input device(s) 420) for manual entry of data or selection of telephone functions, and a display 450 (e.g., of input device(s) 420 or output device(s) 425) that may visually display data to the user and/or which may provide a user interface that the user may use to enter data or to select telephone functions (in conjunction with keypad 445).

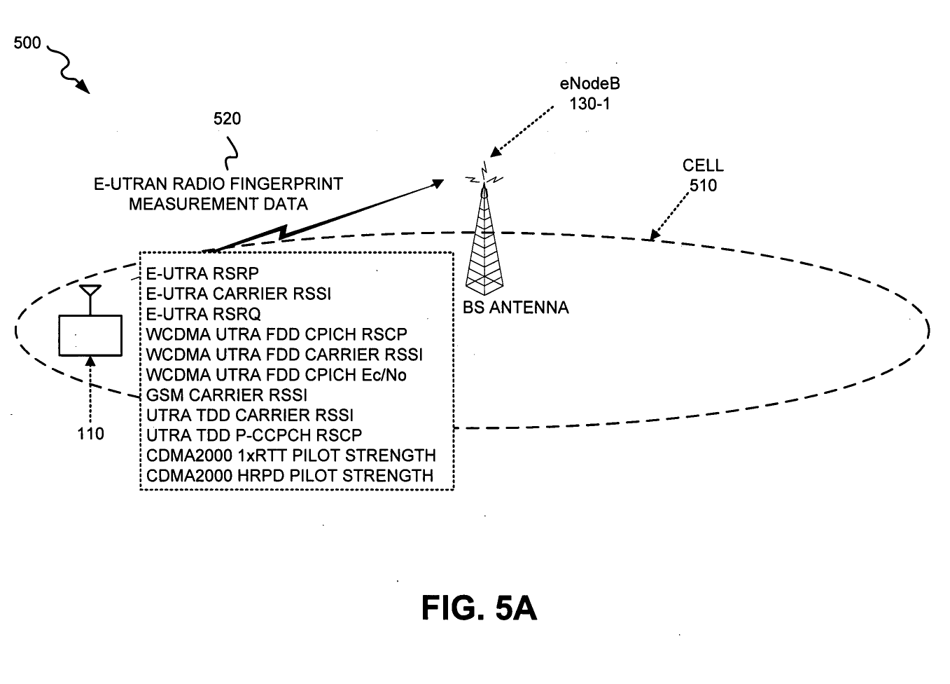

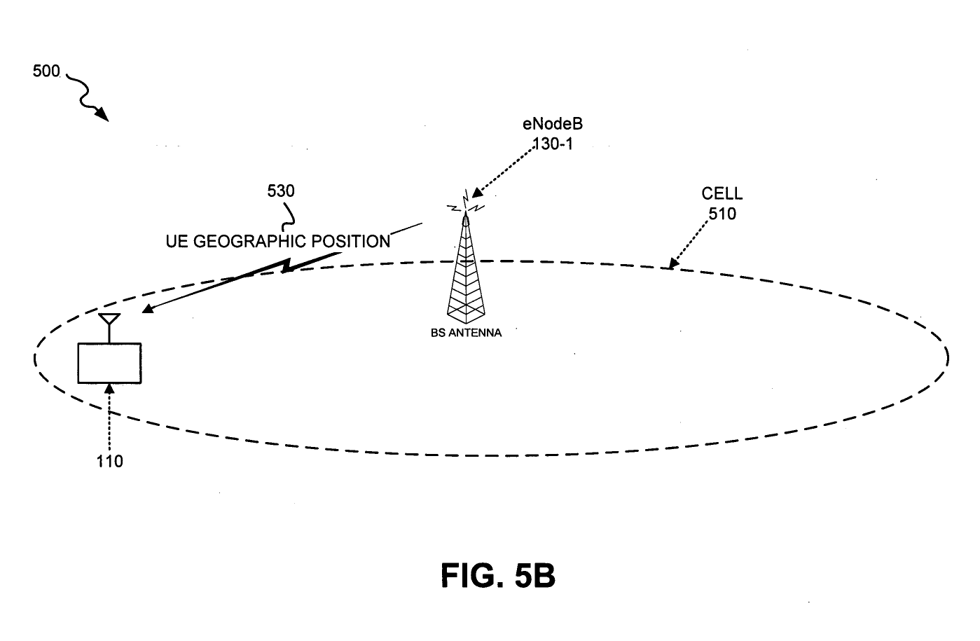

FIG. 5A is a diagram that depicts the uplink transmission of E-UTRAN radio fingerprint measurement data from UE 110 to eNodeB 130-1 in a cell 510 of a wireless network. UE 110 may, at a certain location point in cell 510, perform one or more E-UTRA and/or inter-RAT (IRAT) measurements and may send the results of those measurements as E-UTRAN radio fingerprint measurement data 520 to eNodeB 130-1. E-UTRAN radio fingerprint measurement data 520 may include one or more of the following:

1) E-UTRA reference signal received power (RSRP) measured at the UE;

2) E-UTRA carrier RSSI measured at the UE;

3) E-UTRA RSRQ measured at the UE;

4) WCDMA UTRA FDD CPICH RSCP measured at the UE;

5) WCDMA UTRA FDD carrier RSSI measured at the UE;

6) WCDMA UTRA FDD CPICH Ec/No, corresponding to a received energy per chip divided by a power density in a band, measured at the UE;

7) GSM carrier RSSI measured at the UE;

8) TDD mode UTRA TDD carrier RSSI measured at the UE;

9) UTRA TDD P-CCPCH RSCP measured at the UE;

10) CDMA2000 1×RTT pilot strength measured at the UE; or

11) CDMA2000 HRPD pilot strength measured at the UE.

In other embodiments, E-UTRAN radio fingerprint measurement data 520 may include additional or alternative measurements. Upon receipt of E-UTRAN radio fingerprint measurement data 520 by eNodeB 130-1. eNodeB 130-1 may forward data 520 on to positioning node 140 (not shown) (via GW 210 and PDN 220) for a geographic position determination based on radio fingerprint measurement data 520.

FIG. 5B is a diagram that depicts the downlink transmission of UE 110′s geographic position 530 from eNodeB 130-1 to UE 110 in cell 510 after the performance of a radio fingerprint look-up at positioning node 140 (not shown). eNodeB 130-1 may receive the geographic position 530 from positioning node 140, via PDN 220 and GW 210, and may then transmit it on the downlink to UE 110. Geographic position 530 may include an accurate position of UE 110 obtained by positioning node 140 based on measurement data 520 of FIG. 5A. Geographic position 530 may include, for example, latitude/longitude coordinates, GPS coordinates, a physical address, etc.

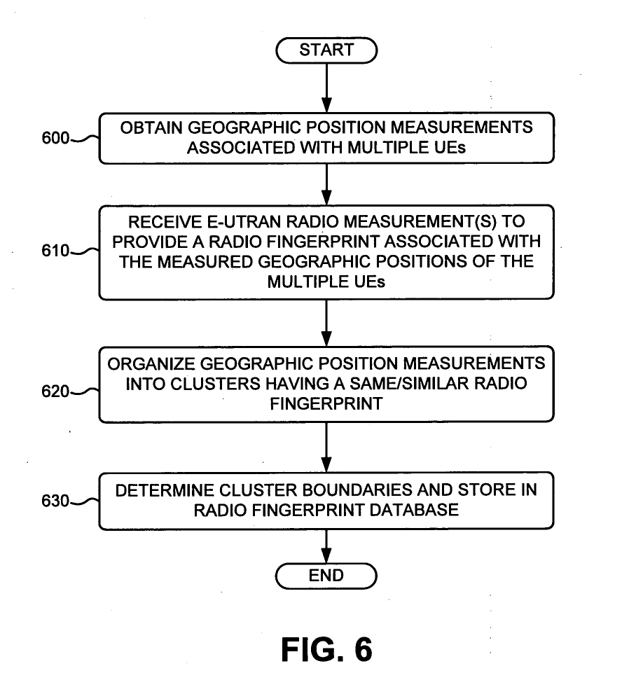

FIG. 6 is a flowchart of an exemplary process for constructing a radio fingerprint database (e.g., database 160) based on E-UTRAN radio measurements received from multiple user equipment devices. The radio fingerprint database constructed using the exemplary process of FIG. 6 may subsequently be used to identify UEs' geographic positions based on E-UTRAN and/or IRAT measurements performed at each of the UEs and sent to positioning node 140 as radio fingerprint measurement data. In one implementation, the exemplary process of FIG. 6 may be implemented by positioning node 140. In another implementation, some or all of the processing described with respect to FIG. 6 may be performed by one or more other devices, including or excluding positioning node 140.

To begin the exemplary process, geographic position measurements associated with multiple UEs, or other position measuring devices may be obtained (block 600). Multiple UEs, or other geographic position measuring devices, located at one or more cells of the PLMN may obtain their geographic positions using an accurate geographic position measuring technique. Any type of position measuring technique that obtains an accurate geographic position may be used. For example, an Assisted GPS (A-GPS) positioning technique may be used to obtain the geographic positions of the multiple UEs. Each of the UEs, or the other position measuring devices, may include GPS receivers that measure the geographic position and GPS reference receivers connected to the PLMN collect assistance data that, when transmitted to GPS receivers at the UEs, or the other position measuring devices, enhance the performance of the GPS receivers in the UEs or other position measuring devices. Typically, A-GPS may be as accurate as +/−10 meters without differential GPS operation. The obtained geographic position measurements may be provided to positioning node 140 either by transmission via network 135 (including or excluding PDN 220), or by transfer from a memory device (e.g., a CD ROM that may be read to transfer position measurements to positioning node 140).

E-UTRAN radio measurements may be received to provide a radio fingerprint associated with the measured geographic positions of the multiple UEs (block 610). The E-UTRAN radio measurements may be performed simultaneously with the geographic position measurements of block 600. The E-UTRAN measurements may include one or more of the following measurements:

1) Evolved Universal Terrestrial Radio Access (E-UTRA) reference signal received power (RSRP) measured at a respective UE;

2) E-UTRA Carrier Received Signal Strength Indicator (E-UTRA carrier RSSI) measured at a respective UE;

3) E-UTRA reference signal received quality (RSRQ) measured at a respective UE;

4) Wideband Code Division Multiple Access (WCDMA) UTRA Frequency Division Duplex (FDD) Common Pilot Channel (CPICH) Received Signal Code Power (RSCP) measured at a respective UE;

5) WCDMA UTRA FDD carrier RSSI measured at a respective UE;

6) WCDMA UTRA FDD CPICH Ec/No, corresponding to a received energy per chip divided by a power density in a band, measured at a respective UE;

7) Global System for Mobile Communications (GSM) carrier RSSI measured at a respective UE;

8) Time division duplex (TDD) mode UTRA TDD carrier RSSI measured at a respective UE;

9) UTRA TDD Primary Common Control Physical Channel (P-CCPCH) RSCP measured at a respective UE;

10) CDMA2000 1 times Radio Transmission Technology (1×RTT) pilot strength measured at a respective UE; and/or

11) CDMA2000 High Rate Packet Data (HRPD) pilot strength measured at a respective UE.

Other types of measurements may additionally or alternatively be used. The E-UTRAN measurements provide a radio “fingerprint” that may be associated with each accurate geographic position measurement.

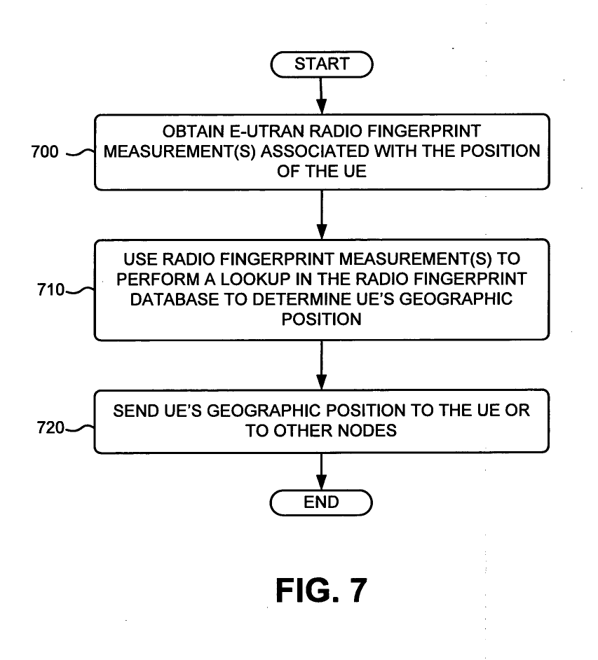

The obtained geographic position measurements may be organized into clusters having a same or similar radio fingerprint (block 620). As numerous geographic position measurements are obtained, they may be organized into clusters based on their respective radio fingerprints. Geographic position measurements may be clustered with other geographic position measurements that have a same or similar radio fingerprint. Boundaries of each of the clusters may be determined and stored in radio fingerprint database 160 (block 630). Analysis of the radio fingerprints and geographic positions of each of the clusters may permit the determination of cluster boundaries that may correspond, for example, to a polygonal shape. The geographic position measurements obtained in block 600, the radio fingerprints received in block 610 and the clusters determined in blocks 620 and 630 may be stored in radio fingerprint database 160 for subsequent geographic position determination, as described below with respect to FIG. 7.

FIG. 7 is a flowchart of an exemplary process for determining a UE's geographic position based on E-UTRAN radio fingerprint measurement associated with a position of the UE. In one implementation, the exemplary process of FIG. 7 may be implemented by positioning node 140. In another implementation, some or all of the processing described with respect to FIG. 7 may be performed by one or more other devices, including or excluding positioning node 140.

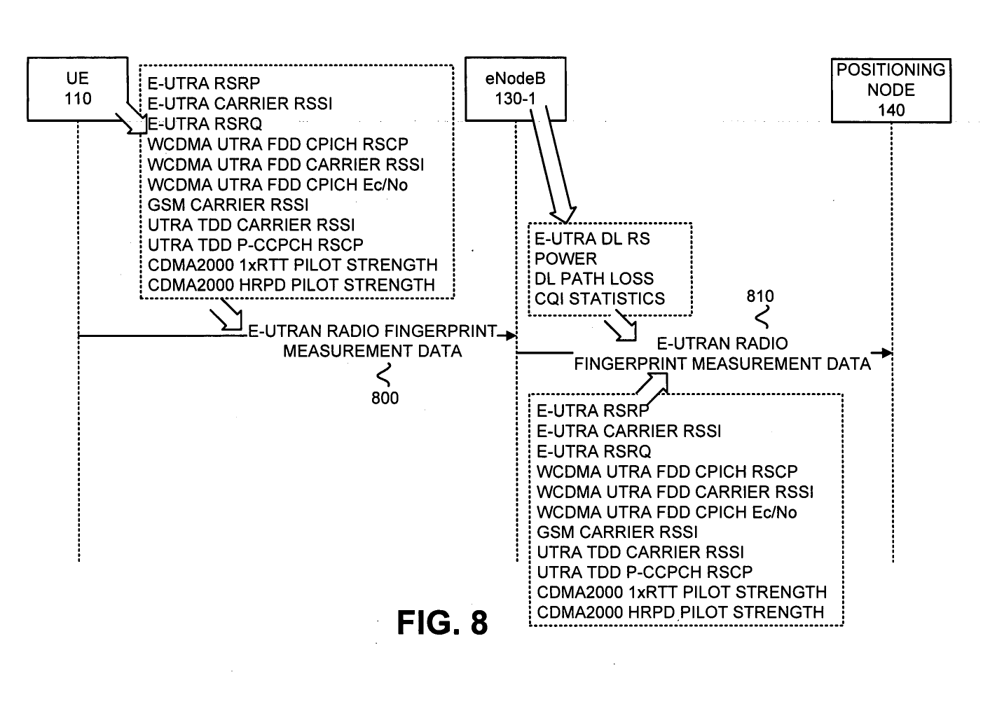

To begin the exemplary process, E-UTRAN radio fingerprint measurement(s) associated with the position of the UE may be obtained (block 700). For example, UE 110 (which for this exemplary process corresponds to a UE that does not have GPS capabilities) may perform E-UTRA measurements and may send the measurement data to positioning node 140. The E-UTRA measurements may include one or more of the types of measurements described above with respect to block 610 of FIG. 6. Additional radio fingerprint measurements may be obtained by the eNodeB that serves UE 110 and provided to positioning node 140. For example, eNodeB 130-1 may measure the E-UTRA Downlink Reference Signal transmit (DL RS) power. eNodeB 130-1 may obtain additional radio fingerprint measurements including, for example, downlink to (DL) path loss, CQI statistics, etc. eNodeB 130-1 may further obtain its own identifier for inclusion in the outgoing message. FIG. 8 is a messaging diagram that depicts the transmission of E-UTRAN radio fingerprint measurement data from UE 110 to eNodeB 130-1, and from eNodeB 130-1 to positioning node 140 for a determination of UE 110's geographic position based on the fingerprint measurement data. As shown in FIG. 8, UE 110 performs one or more radio fingerprint measurements (e.g, one or more of the types of measurements described above with respect to block 610) and sends those measurements as E-UTRAN radio fingerprint measurement data 800 to eNodeB 130-1. eNodeB 130-1 may perform one or more additional radio fingerprint measurements (e.g., E-UTRA RS DL power), may add those measurements to the measurement data 800 received from UE 110, and may then send E-UTRAN radio fingerprint measurement data 810 to positioning node 140 that includes radio fingerprint measurements performed at both UE 110 and eNodeB 130-1.

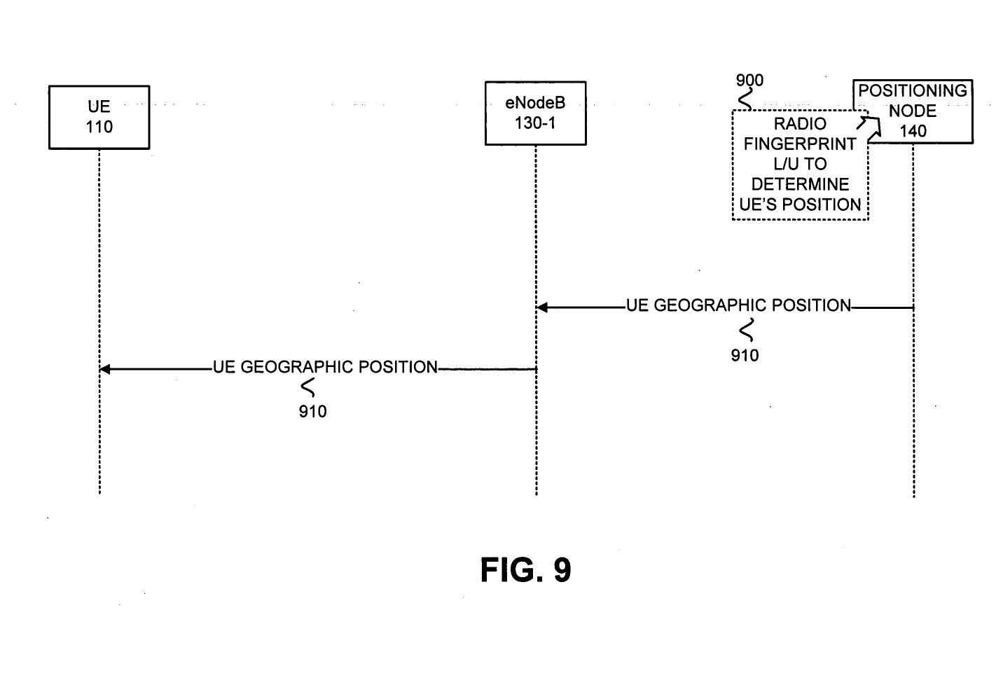

Returning to FIG. 7, the obtained radio fingerprint measurement(s) may be used to perform a lookup in radio fingerprint database 160 to determine the UE's geographic position (block 710). The lookup into radio fingerprint database 160 may include matching the radio fingerprint measurement(s) obtained in block 700 with previously stored radio fingerprint measurements stored in database 160. The geographic position data stored in database 160, that corresponds to matching radio fingerprint measurements, may be retrieved as the UE's geographic position. Positioning node 140 may send this retrieved geographic position to the UE from which the E-UTRAN radio fingerprint data was received, or to other nodes external to the PLMN (e.g., to GIS server 150, an emergency or police call center, etc.) (block 720). FIG. 9 is a messaging diagram that depicts the transmission of UE 110's geographic position, determined based on E-UTRAN radio fingerprint measurement data received at positioning node 140, from positioning node 140 to eNodeB 130-1, and from the eNodeB 130-1 to the UE 110. As shown in FIG. 9, positioning node 140 may perform a radio fingerprint lookup 900 to obtain the UE's geographic position, and then may send a message 910 that includes the determined geographic position to eNodeB 130-1. eNodeB 130-1 may receive message 910 and forward it on to UE 110. Though not shown in FIG. 9, other entities may send a location request to positioning node 140 to request a geographic position associated with one or more specific UEs, and positioning node 140 may return a geographic position that corresponds to the last reported position of the one or more specific UEs.

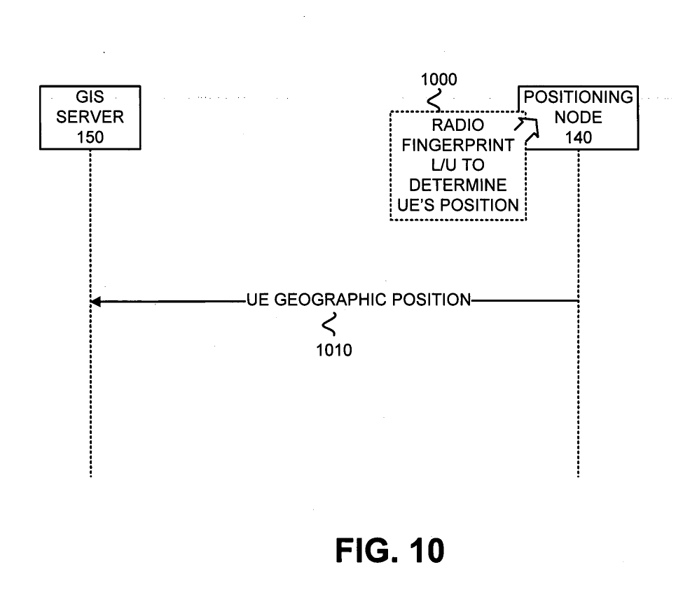

FIG. 10 is a messaging diagram that depicts the transmission of a UE's geographic position, determined based on E-UTRAN radio fingerprint measurement data received at positioning node 140, from positioning node 140 to GIS server 150. As shown in FIG. 10, positioning node 140 may perform a radio fingerprint lookup 1000 to obtain the UE's geographic position, and then may send a message 1010 that includes the determined geographic position to GIS server 150. GIS server 150 may map the geographic position to physical coordinates or a physical address, or perform other mapping related services with the geographic position.

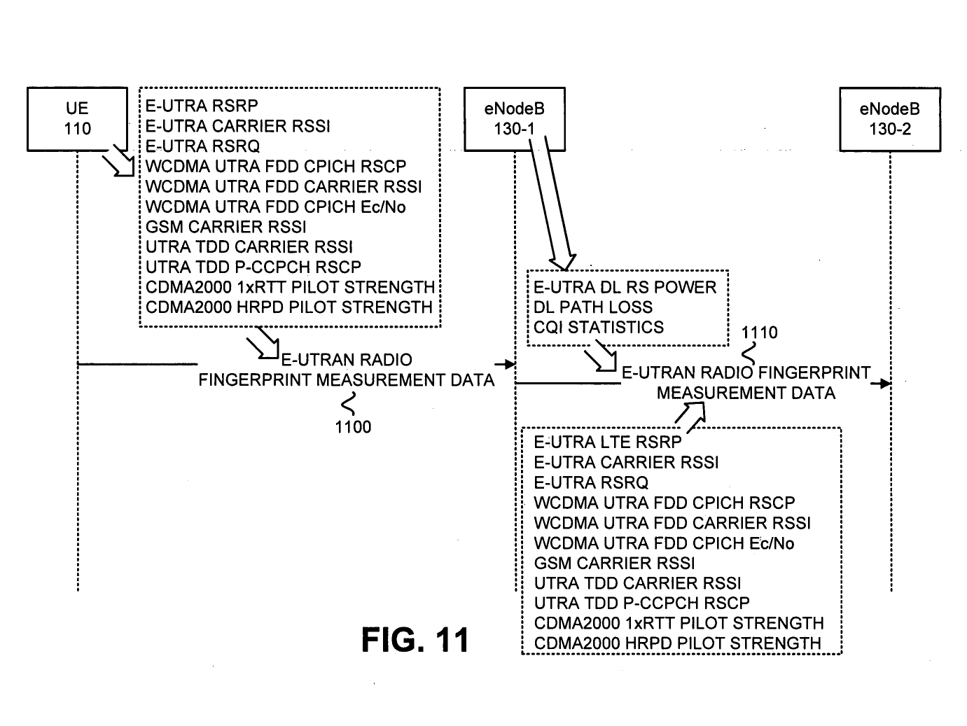

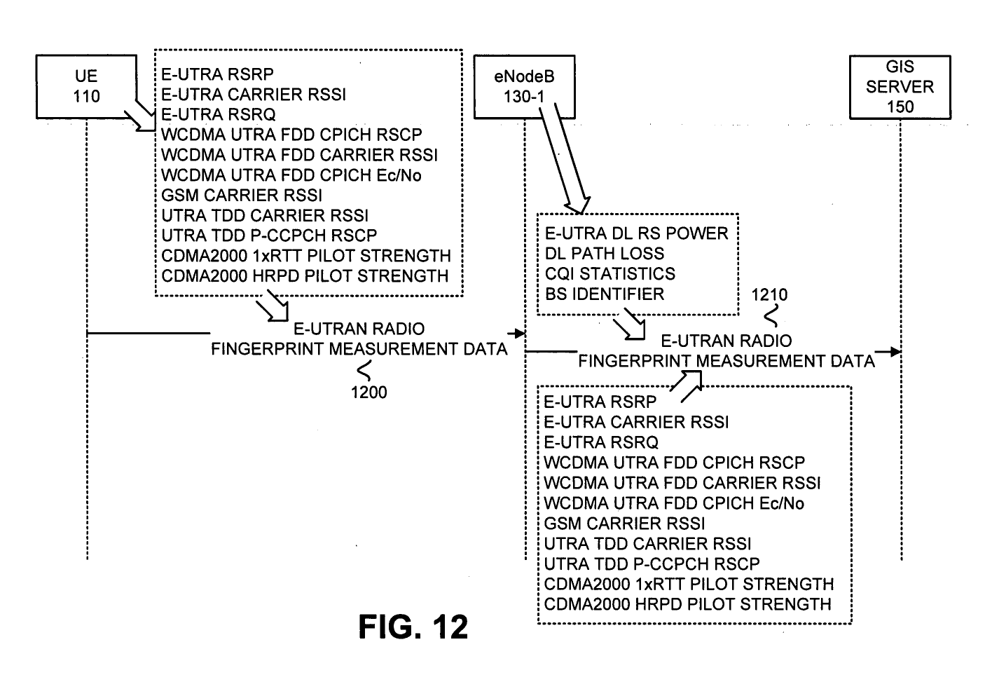

FIGS. 11 and 12 depict additional examples of E-UTRAN radio fingerprint messaging. In the example of FIG. 11, E-UTRAN radio fingerprint measurement data may be sent from UE 110 to eNodeB 130-1 that is serving UE 110 and then on to another eNodeB 130-2 that is serving another cell in the PLMN. eNodeB 130-1 may signal the radio fingerprint measurement data to eNodeB 130-2 via, for example, an X2 interface. As shown in the example of FIG. 11, E-UTRAN radio fingerprint measurements may be performed at UE 110, and the measurement data may be incorporated into an E-UTRAN radio fingerprint measurement data message 1100. Message 1100 may be sent from UE 110 to eNodeB 130-1, which is currently serving UE 110. eNodeB 130-1 may perform one or more additional radio fingerprint measurements (e.g., E-UTRA RS DL power), may add those measurements to the measurement data 1100 received from UE 110, and may then send an E-UTRAN radio fingerprint measurement data message 1110 on to eNodeB 130-2.

In the example of FIG. 12, E-UTRAN radio fingerprint measurement data may be sent from UE 110 to GIS server 150. UE 110 may signal the radio fingerprint measurement data to GIS server 150 via a Secure User Plane Location (SUPL)-type interface. As shown in the example of FIG. 12, E-UTRAN radio fingerprint measurements may be performed at UE 110, and the measurement data may be incorporated into an E-UTRAN radio fingerprint measurement data message 1200. Message 1200 may be sent from UE 110 to eNodeB 130-1, which is currently serving UE 110. eNodeB 130-1 may perform one or more additional radio fingerprint measurements (e.g., E-UTRA RS DL power), may add those measurements to the measurement data 1200 received from UE 110, and may then send an E-UTRAN radio fingerprint measurement data message 1210 on to GIS server 150. GIS server 150 may use the radio fingerprint measurement data to build up mappings of cell IDs/network IDs tagged with accurate geographic positions.

### CONCLUSION

The foregoing description of implementations provides illustration and description, but is not intended to be exhaustive or to limit the invention to the precise form disclosed. Modifications and variations are possible in light of the above teachings, or may be acquired from practice of the invention. For example, while series of blocks have been described with regard to FIGS. 6 and 7, the order of the blocks may be modified in other implementations consistent with the principles of the invention. Further, non-dependent blocks may be performed in parallel.

Aspects of the invention may also be implemented in methods and/or computer program products. Accordingly, the invention may be embodied in hardware and/or in hardware/software (including firmware, resident software, microcode, etc.). Furthermore, the invention may take the form of a computer program product on a computer-usable or computer-readable storage medium having computer-usable or computer-readable program code embodied in the medium for use by or in connection with an instruction execution system. The actual software code or specialized control hardware used to implement embodiments described herein is not limiting of the invention. Thus, the operation and behavior of the aspects were described without reference to the specific software code—it being understood that one would be able to design software and control hardware to implement the aspects based on the description herein.

Furthermore, certain portions of the invention may be implemented as “logic” that performs one or more functions. This logic may include hardware, such as an application specific integrated circuit or field programmable gate array or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

It should be emphasized that the term “comprises/comprising” when used in this specification is taken to specify the presence of stated features, integers, steps, components or groups but does not preclude the presence or addition of one or more other features, integers, steps, components or groups thereof.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1-17. (canceled)

18. A method in a positioning node associated with a wireless network of obtaining geographic positions associated with location points of multiple user equipments (UEs) in the wireless network, the method comprising:
receiving Evolved Universal Terrestrial Radio Access Network (E-UTRAN) radio fingerprint data associated with radio measurements performed at the location points by the multiple UEs or performed by Evolved NodeBs (eNodeBs) associated with the multiple UEs;
clustering the location points based on similarities between the E-UTRAN radio fingerprint data to create cluster boundaries; and
storing the geographic positions, cluster boundaries, and E-UTRAN radio fingerprint data in a database for future determination of UE geographic positions using the E-UTRAN radio fingerprint data.

19. The method of claim 18, wherein the cluster boundaries have polygon forms.

20. The method of claim 18, wherein the E-UTRAN radio fingerprint data comprises at least one of:
Evolved Universal Terrestrial Radio Access (E-UTRA) reference signal received power (RSRP) measured at a respective UE of the multiple UEs;
E-UTRA carrier Received Signal Strength Indicator (RSSI) measured at a respective UE of the multiple UEs;
E-UTRA Reference Signal Received Quality (RSRQ) measured at a respective UE of the multiple UEs;
Wideband Code Division Multiple Access (WCDMA) Universal Terrestrial Radio Access (UTRA) Frequency Division Duplex (FDD) Common Pilot Channel (CPICH) Received Signal Code Power (RSCP) measured at a respective UE of the multiple UEs;
WCDMA UTRA FDD carrier RSSI measured at a respective UE of the multiple UEs;
WCDMA UTRA FDD CPICH received energy per chip divided by band power density (Ec/No) measured at a respective UE of the multiple UEs;
Global System for Mobile Communications (GSM) carrier RSSI measured at a respective UE of the multiple UEs;
UTRA Time Division Duplex (TDD) carrier RSSI measured at a respective UE of the multiple UEs;
UTRA TDD Primary Common Control Physical Channel (P-CCPCH) RSCP measured at a respective UE of the multiple UEs;
CDMA2000 1×Radio Transmission Technology (1×RTT) pilot strength measured at a respective UE of the multiple UEs;
CDMA2000 High Rate Packet Data (HRPD) pilot strength measured at a respective UE of the multiple UEs; and
E-UTRA Downlink Reference Signal (DL RS) transmit power measured at an eNodeB associated with a respective UE of the multiple UEs.

21. The method of claim 18, further comprising obtaining the geographic positions associated with the location points using a Global Positioning System (GPS) device.

22. The method of claim 18, further comprising:
receiving E-UTRAN radio fingerprint measurement data associated with a first UE in the wireless network;
performing a lookup operation in the database to retrieve one of the geographic positions that corresponds to the E-UTRAN radio fingerprint measurement data; and
sending the one of the geographic positions to at least one of the first UE, an emergency or police call center, a geographic information system (GIS) server, and a node external to the wireless network.

23. The method of claim 22, wherein the one of the geographic positions is sent via an X2 interface or an interface based on a Secure User Plane Location (SUPL) interface.

24. The method of claim 22, wherein performing the lookup operation in the database comprises matching the E-UTRAN radio fingerprint measurement data associated with the first UE with E-UTRAN radio fingerprint data stored in the database to retrieve the one of the geographic positions.

25. The method of claim 22, wherein the E-UTRAN radio fingerprint measurement data comprises data associated with measurements performed at the first UE and comprises at least one of:
Evolved Universal Terrestrial Radio Access (E-UTRA) Reference Signal Received Power (RSRP) measured at the first UE;
E-UTRA carrier Received Signal Strength Indicator (RSSI) measured at the first UE;
E-UTRA Reference Signal Received Quality (RSRQ) measured at the first UE;
Wideband Code Division Multiple Access (WCDMA) Universal Terrestrial Radio Access (UTRA) Frequency Division Duplex (FDD) Common Pilot Channel (CPICH) Received Signal Code Power (RSCP) measured at the first UE;
WCDMA UTRA FDD carrier RSSI measured at the first UE;
WCDMA UTRA FDD CPICH received energy per chip divided by band power density (Ec/No) measured at the first UE;
Global System for Mobile Communications (GSM) carrier RSSI;
UTRA Time Division Duplex (TDD) carrier RSSI measured at the first UE;
UTRA TDD Primary Common Control Physical Channel (P-CCPCH) RSCP measured at the first UE;
CDMA2000 1× Radio Transmission Technology (1×RTT) pilot strength measured at the first UE; or
CDMA2000 High Rate Packet Data (HRPD) pilot strength measured at the first UE.

26. The method of claim 25, wherein the E-UTRAN radio fingerprint measurement data further comprises data associated with at least one measurement performed at an eNodeB associated with the first UE, and the at least one measurement comprises E-UTRA Downlink Reference Signal (DL RS) transmit power measured at the eNodeB.

27. A user equipment (UE) for a wireless communication system, comprising:
a transceiver configured to perform radio measurements to obtain Evolved Universal Terrestrial Radio Access Network (E-UTRAN) radio fingerprint measurement data associated with a geographic position of the UE, wherein the E-UTRAN radio fingerprint measurement data comprises at least one of:
Evolved Universal Terrestrial Radio Access (E-UTRA) Reference Signal Received Power (RSRP) measured at the UE;
E-UTRA carrier Received Signal Strength Indicator (RSSI) measured at the UE;
E-UTRA Reference Signal Received Quality (RSRQ) measured at the UE;
Wideband Code Division Multiple Access (WCDMA) Universal Terrestrial Radio Access (UTRA) Frequency Division Duplex (FDD) Common Pilot Channel (CPICH) Received Signal Code Power (RSCP) measured at the UE;
WCDMA UTRA FDD carrier RSSI measured at the UE;
WCDMA UTRA FDD CPICH received energy per chip divided by band power density (Ec/No) measured at the UE;
Global System for Mobile Communications (GSM) carrier RSSI measured at the UE;
UTRA Time Division Duplex (TDD) carrier RSSI measured at the UE;
UTRA TDD Primary Common Control Physical Channel (P-CCPCH) RSCP measured at the UE;
CDMA2000 1× Radio Transmission Technology (1×RTT) pilot strength measured at the UE; and
CDMA2000 High Rate Packet Data (HRPD) pilot strength measured at the UE; and
a processing unit configured to cause the E-UTRAN radio fingerprint measurement data to be sent to a geographic position determining node and the UE to receive a current geographic position from the geographic position determining node responsive to sending the E-UTRAN radio fingerprint measurement data.

28. A positioning node associated with a wireless network, comprising:
a database;
an interface configured to receive geographic positions associated with location points of multiple user equipments (UEs) in the wireless network obtained using a Global Positioning System (GPS) device, and to receive Evolved Universal Terrestrial Radio Access Network (E-UTRAN) radio fingerprint data associated with radio measurements performed at the location points of the multiple UE; and
a processing unit configured to cluster the location points based on similarities between the E-UTRAN radio fingerprint data to create cluster boundaries; and to store the geographic positions, cluster boundaries, and the E-UTRAN radio fingerprint data in the database for future determination of UE geographic positions using the E-UTRAN radio fingerprint data without use of the GPS device.

29. The node of claim 28, wherein the cluster boundaries have polygon forms.

30. The node of claim 28, wherein the E-UTRAN radio fingerprint data comprises at least one of:
Evolved Universal Terrestrial Radio Access (E-UTRA) Reference Signal Received Power (RSRP) measured at a respective UE;
E-UTRA carrier Received Signal Strength Indicator (RSSI) measured at a respective UE;
E-UTRA Reference Signal Received Quality (RSRQ) measured at a respective UE;
Wideband Code Division Multiple Access (WCDMA) Universal Terrestrial Radio Access (UTRA) Frequency Division Duplex (FDD) Common Pilot Channel (CPICH) Received Signal Code Power (RSCP) measured at a respective UE;
WCDMA UTRA FDD carrier RSSI measured at a respective UE;
WCDMA UTRA FDD CPICH received energy per chip divided by band power density (Ec/No) measured at a respective UE;
Global System for Mobile Communications (GSM) carrier RSSI measured at a respective UE;
UTRA Time Division Duplex carrier RSSI measured at a respective UE;
UTRA TDD Primary Common Control Physical Channel (P-CCPCH) RSCP measured at a respective UE;
CDMA2000 1× Radio Transmission Technology (1×RTT) measured at a respective UE;
CDMA2000 High Rate Packet Data (HRPD) pilot strength measured at a respective UE; and
E-UTRA Downlink Reference Signal (DL RS) transmit power measured at an Evolved NodeB (eNodeB) associated with a respective UE.

31. The node of claim 28, wherein the interface is further configured to receive E-UTRAN radio fingerprint measurement data associated with a first UE in the wireless network; and the processing unit is further configured to perform a lookup operation in the database to retrieve one of the geographic positions by matching the received E-UTRAN radio fingerprint measurement data with at least one of the E-UTRAN radio fingerprint data stored in the database, and to arrange to send the one of the geographic positions to at least one of the first UE, an emergency or police call center, a geographic information system (GIS) server, and a node external to the wireless network.

32. The node of claim 31, wherein the processing unit is further configured, when performing the lookup operation in the database, to match the E-UTRAN radio fingerprint measurement data associated with the first UE with E-UTRAN radio fingerprint data stored in the database to retrieve the one of the geographic positions.

33. The node of claim 31, wherein the E-UTRAN radio fingerprint measurement data comprises data associated with measurements performed at the first UE and comprises at least one of:
Evolved Universal Terrestrial Radio Access (E-UTRA) Reference Signal Received Power (RSRP) measured at the first UE;
E-UTRA carrier Received Signal Strength Indicator (RSSI) measured at the first UE;
E-UTRA Reference Signal Received Quality (RSRQ) measured at the first UE;
Wideband Code Division Multiple Access (WCDMA) Universal Terrestrial Radio Access (UTRA) Frequency Division Duplex (FDD) Common Pilot Channel (CPICH) Received Signal Code Power (RSCP) measured at the first UE;
WCDMA UTRA FDD carrier RSSI measured at the first UE;
WCDMA UTRA FDD CPICH received energy per chip divided by band power density (Ec/No) measured at the first UE;
Global System for Mobile Communications (GSM) carrier RSSI measured at the first UE;
UTRA Time Division Duplex (TDD) carrier RSSI measured at the UE;
UTRA TDD Primary Common Control Physical Channel (P-CCPCH) RSCP measured at the first UE;
CDMA2000 1× Radio Transmission Technology (1×RTT) pilot strength measured at the first UE; and
CDMA2000 High Rate Packet Data (HRPD) pilot strength measured at the first UE.

34. The node of claim 33, wherein the E-UTRAN radio fingerprint measurement data further comprises data associated with at least one measurement performed at an Evolved NodeB (eNodeB) associated with the first UE, and the at least one measurement comprises E-UTRA Downlink Reference Signal (DL RS) transmit power measured at the eNodeB.
